(19) United States
(12) Patent Application Publication
(10) Pub. No.: US 2022/0075650 A1
(43) Pub. Date: Mar. 10, 2022

(54) CACHED AND PIPELINED EXECUTION OF SOFTWARE MODULES

(71) Applicant: Element Al Inc., Montreal (CA)

(72) Inventors: Lorne SCHELL, Montreal (CA); Francis DUPLESSIS, Montreal (CA)

(73) Assignee: Element Al Inc., Montreal, QC (CA)

(21) Appl. No.: 17/416,769

(22) PCT Filed: Dec. 18, 2019
(86) PCT No.: PCT/CA2019/051848

§ 371 Date: Jun. 21, 2021

Related U.S. Application Data
(60) Provisional application No. 62/783,370, filed on Dec. 21, 2018.

(51) Int. Cl. G06F 9/48

(52) U.S. Cl. CPC G06F 9/4881; G06F 11/3668

(57) ABSTRACT

Systems and methods for executing software modules in a pipelined fashion. A listing of modules to be executed is received and each module is executed in turn. Prior to execution, each module is code and input checked to determine if it corresponds to a previously executed module. If there is correspondence, then cached results from the previously executed module is used in place of executing the module. If there is no correspondence, then the module is executed, and its results are cached such that these results are available to subsequently executed modules. At least one of the modules may be an implementation of a machine learning model.

### TECHNICAL FIELD

The present invention relates to computer science. More specifically, the present invention relates to methods and systems for a more efficient method of executing software modules, especially for testing and validating software modules that implement machine learning models.

### BACKGROUND

Recent advances in the fields of artificial intelligence and machine learning has made these fields some of the most exciting in the usually staid field of computer science. These advances have given us a glimpse of the possibilities of the future—a future where we are free of the encumbrances of work, where machines can learn and manage the boring details of everyday life. However, one unspoken truism of such a future is that the machines and the software that would run such a world need to be developed. And, to develop such machine learning models and, more importantly, their implementations, can be time consuming. Numerous tests have to be run to ensure correct functioning of the implementations of the machine learning models and such models would need to be trained on numerous datasets to ensure not just correct but optimal functioning.

Currently, machine learning models are tested by hand as developers struggle with inadequate tools to test, retest, run, and rerun multiple machine learning models on different datasets and different generated data. Pipelining tools that may help are, of course, available. However, even with such tools, each test and model run still needs to have its data properly generated, that data adjusted (if necessary), and to have the data applied to the module that implements the model. Once the data has been applied, other steps need to be performed. As an example, the results would need to be separately validated, analyses of the resulting data would need to be performed, graphs generated on the data, etc., etc. Only at the very end would the developer know whether the implementation of the model is suitable for its intended purpose or whether the implementation (or the model) needs to be tweaked or adjusted wholesale.

As can be imagined, the above scenario entails numerous hours of not just coding but also numerous hours of running time as each set of modules that implement the model, generate the potentially large data sets of results, validate the results, and analyze the result would need to be executed separately. Unfortunately, even if numerous GPUs are tasked with this, the running time can still run into hours upon hours and results may not be ready for days.

In addition to the delays in executing the various modules necessary for implementing different models or different variants of the same model (e.g. to determine which variant works best), there is the added roadblock of differing standards and frameworks. The various tools, environments, and languages used to implement machine learning models do not necessarily work with one another, leading to debates and factions that seemingly pledge allegiance to one camp or another. A tool or module that exhibits usefulness in one environment may not even work in another environment.

From the above, there is therefore a need for systems and methods that mitigate if not overcome the shortcomings noted above. The delays in executing the multiple modules necessary to implement, test, and validate various implementations of machine learning models are, preferably, lessened if not eliminated.

### SUMMARY

The present invention provides systems and methods for executing software modules in a pipelined fashion. A listing of modules to be executed is received and each module is executed in turn. Prior to execution, each module's code and input are checked to determine if it corresponds to a previously executed module. If there is correspondence, then cached results from the previously executed module is used in place of executing the module. If there is no correspondence, then the module is executed, and its results are cached such that these results are available to subsequently executed modules. This cache of precomputed results may be shared amongst a team working on a common set of software modules. At least one of the modules may be an implementation of a machine learning model.

In a first aspect, the present invention provides a method for executing a plurality of software modules, the method comprising:
a) receiving a listing of modules to be executed;
b) receiving an order of execution for said listing modules, said order indicating which modules are to be run and in what order;
c) sequentially executing each module in said listing in turn;
d) caching outputs of each module in multiple locations such that subsequently executed modules have access to said outputs;
   wherein, in the event a specific module being executed has inputs and code that is in common with a previously executed module, an output of said previously executed module is retrieved from one of said multiple locations and is used as an output of said specific module and said specific module is not executed.

In a second aspect, the present invention provides computer readable media having encoded thereon computer readable instructions which, when executed, implements a method for executing a plurality of software modules, the method comprising:
a) receiving a listing of modules to be executed;
b) sequentially executing each module in said listing in turn;
c) caching outputs of each module in multiple locations such that subsequently executed modules have access to said outputs;
   wherein, in the event a specific module being executed has inputs and code that is in common with a previously executed module, an output of said previously executed module is retrieved from one of said multiple locations and is used as an output of said specific module and said specific module is not executed.

### BRIEF DESCRIPTION OF THE DRAWINGS

The embodiments of the present invention will now be described by reference to the following FIGURES, in which identical reference numerals in different FIGURES indicate identical elements and in which:

FIG. 1 is a flowchart detailing the steps in a method according to one aspect of the present invention.

### DETAILED DESCRIPTION

In one aspect, the present invention allows for a sequential execution of a number of software modules. One or more of these modules may be implementations of machine learning models. Other modules may generate data for these implementation modules and others may adjust/augment the generated data prior to the data being applied to the implementation modules.

Initially, a listing of the modules to be executed is received, either by way of a command line or some other suitable means, including, but not limited to a configuration file, an Abstract Program Interface (API), or a Domain Specific Language (DSL). This listing may be used to determine the order of execution of the modules or an explicit order of execution listing is received. This ensures that the modules are executed in the order desired by the user. The various modules are then executed in the given order, with the results from each module being cached or saved otherwise so that subsequently executed modules have access to these results. It should be clear that, prior to executing a module, the system introspects (i.e. examines) the module to be executed and checks that module's code and inputs, without any modification of the module being inspected and agnostic of the framework the module is a part of. If the module's code and inputs correspond to a module that has already been executed, the system does not execute that module and, instead, the cached or saved version of the corresponding module's output is retrieved. This retrieved output is then used as the output of the module that has not been executed.

It should also be clear that the concept noted above may be applied to submodules within each module. If a submodule within a module to be executed has common code and inputs to a previously executed submodule, the unexecuted submodule is not executed and the cached results from the previously executed submodule is used. This is may be performed concurrently with multiple modules being processed simultaneously.

It should also be clear that the present invention may be implemented using a variety of methods. In one implementation, Python was used to create the system and the resulting tool may be called from a Unix command line. In this implementation, one specific example of the resulting pipeline is given as:

Module_runner ({“name”: “my_module_pipeline”;

Modules [ “Generator”

“Augmentor”,

“Model”,
“Validation”,

“AutomaticGraphModule”]})

The above pipeline denotes that the modules “Generator”, “Augmentor”, “Model”, “Validation”, and “AutomaticGraphModule” are to be executed sequentially in the order given. For this example, Generator generates the data to be used by the module Model (which is an implementation of a machine learning model). Once Generator generates the data, the data is augmented or adjusted by the module Augmentor. The resulting data from the Model module is then sent to be validated by the Validation module and, once validated, the resulting data is graphed by the final module.

As noted above, the various outputs of the various modules are cached by the system. This may be done by storing the outputs in memory, on to disk, or on another system over a computer network. These outputs are, of course, cached so that they may be accessed by the subsequently executed modules without necessarily re-executing a module to produce the same output. In this specific implementation, the cache exists as a tiered cache in all above-mentioned locations. These various locations are checked, in a specific order, for the existence of a precomputed result. If a precomputed result is found, then the first one found is used. As can be imagined, when a new computation is performed, the result of this new computation is then stored at all of the locations. This allows the result to be available to multiple modules and to multiple users, regardless of who executes the original computation. This also ensures that the results are not lost when machines are turned off and also ensures that data access concerns are not an issue for members of the team.

It should be clear that the above example may be easily extended to include multiple implementation modules of machine learning models. As an example, instead of a single Model module, the above may have Model1, Model2, Model3 modules (along with duplication of the Generator and Augmentor modules), with each being a variant implementation of the same machine learning model and with each one being used with the same dataset resulting from the Generator and Augmentor modules. For such an example, since the Generator module results are cached and since the Augmentor module results are similarly cached, then the system would not need to re-execute the Generator and Augmentor modules. Instead, the system would be keyed to the code, the input, and the parameters to the Generator and Augmentor modules and would know to NOT re-execute these modules. The results from the previously executed Generator and Augmentor modules would be retrieved and would thus be used instead of re-executing the modules. Since, in some cases, executing a generator module may take many hours, this capability of the present invention can save many hours in the execution time of the extended example. This capability also allows the results to be shared in common within a team such that only one team member is required to run the computation on their computer and all team members have access to the computed result.

In addition to the above, the present invention is, preferably, implemented in a system that can call objects or modules from different environments. This would thus allow the system to call and execute modules from other environments and that, as such, the present invention would be environment agnostic. As noted above, in one implementation, Python in a Unix environment was used.

The present invention thus improves on the pipeline capability for use in the execution of multiple implementations of machine learning models, especially in collaborative teams. Instead of having to manually execute each implementation, a developer can simply chain the execution of multiple implementations using a single dataset (or multiple datasets) while only having to generate the dataset once. In addition, the present invention allows for the use of tools that may not normally work due to differing environments. It should be clear that, while seemingly similar to a batching script, the present invention provides the added advantage of caching the results of each executed module. This allows subsequently executed modules to access these results without having to re-run or re-execute the previous modules. In addition, the present invention allows for the use of modules that, previously, would not have been able to run in the same environment.

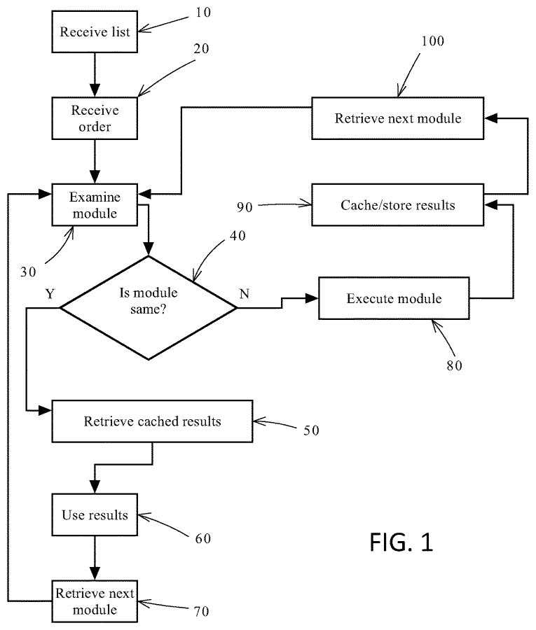

Referring to FIG. 1, a flowchart detailing the steps in a method according to one aspect of the present invention is illustrated. In step 10, a listing of modules to be executed is received. An order of execution for these modules may also be received in step 20, even though, in some implementations, the listing may serve to provide this order of execution. In step 30, prior to executing a module, the module is introspected (i.e. examined and analyzed) to check for code and input similarities to previously executed modules and to determine the method in which to run the module. Check 40 then determines if the module is similar in code and input to a previously executed module. If the answer is yes, then step 50 is that of retrieving the results of that previously executed module. Step 60 then uses those results in place of the module. The method then, in step 70, moves on to the next module and the method loops back to step 30. On the other hand, if the check in step 40 shows that the module does not have a similarity in code and input to a previously executed module, the module is executed (step 80). The results from this execution is then cached or stored in step 90. The next module is then retrieved (step 100) and the method loops back to step 30.

It should be clear that the various aspects of the present invention may be implemented as software modules in an overall software system. As such, the present invention may thus take the form of computer executable instructions that, when executed, implements various software modules with predefined functions.

The embodiments of the invention may be executed by a computer processor or similar device programmed in the manner of method steps or may be executed by an electronic system which is provided with means for executing these steps. Similarly, an electronic memory means such as computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g., “C” or “Go”) or an object-oriented language (e.g., “C++”, “java”, “PHP”, “PYTHON” or “C#”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

What is claimed is:

1. A method for executing a plurality of software modules, the method comprising:
a) receiving a listing of modules to be executed;
b) receiving an order of execution for said listing modules, said order indicating which modules are to be run and in what order;
c) sequentially executing each module in said listing in turn;
d) caching outputs of each module in multiple locations such that subsequently executed modules have access to said outputs.
wherein, in the event a specific module being executed has inputs and code that is in common with a previously executed module, an output of said previously executed module is retrieved from one of said multiple locations and is used as an output of said specific module and said specific module is not executed.

2. The method according to claim 1, wherein at least one of said software modules is an implementation of a machine learning model.

3. The method according to claim 2, wherein at least one of said software modules is a generator module for generating data for use by said implementation of a machine learning module.

4. The method according to claim 3, wherein at least two of said software modules are implementations of machine learning models and said implementations are to be executed using at least one set of data generated by said generator module.

5. The method according to claim 4, wherein at least one of said software modules is an augmentor module for adjusting said at least one set of data generated by said generator module.

6. The method according to claim 1, wherein at least two of said software modules are variant implementations of a specific machine learning model.

7. The method according to claim 6, wherein at least one of said software modules is a generator module for generating data for use by said variant implementations of said specific machine learning module.

8. The method according to claim 7, wherein at least one of said software modules is an augmentor module for adjusting data generated by said generator module.

9. The method according to claim 1, wherein at least one of said software modules is a module for graphing results from a previously executed module.

10. The method according to claim 1, wherein said method includes a step of examining each module prior to execution to determine if said module has a same code and input as a previously executed module.

11. The method according to claim 1, wherein said method further comprises a step of facilitating a distribution of access to at least one of said multiple locations to a plurality of specific users.

12. The method according to claim 1, wherein said method further comprises a step of facilitating a distribution of access to at least one of said multiple locations to a plurality of software modules such that said software modules have access to said output.

13. Computer readable media having encoded thereon computer readable instructions which, when executed, implements a method for executing a plurality of software modules, the method comprising:
a) receiving a listing of modules to be executed;
b) sequentially executing each module in said listing in turn;
c) caching outputs of each module in multiple locations such that subsequently executed modules have access to said outputs;
wherein, in the event a specific module being executed has inputs and code that is in common with a previously executed module, an output of said previously executed module is retrieved from one of said multiple locations and is used as an output of said specific module and said specific module is not executed.
